(19) United States
(12) Patent Application Publication
(10) Pub. No.: US 2002/0102524 A1
(43) Pub. Date: Aug. 1, 2002

(54) System and method for developing instructional materials using a content database

(76) Inventors: Steven D. Rizzi, Annapolis, MD (US); Tim M. Nelson, Annapolis, MD (US); Sue Z. Boyer, Annapolis, MD (US); Ronald Clifford Rescigno, Westlake Village, CA (US)

Correspondence Address: FOLEY & LARDNER, Washington Harbour, Suite 500, 3000 K Street, N.W., Washington, DC, 20007-5109, US

(21) Appl. No.: 09/769,364

(22) Filed: Jan. 26, 2001

(51) Int. Cl. G09B 3/00

(52) U.S. Cl. 434/350

(57) ABSTRACT

A content editing system allows developers of instructional materials to edit and design the instructional materials from a database of content. The instructional material can be displayed in a first format if the viewer of the instructional material is of a first type and displayed in a second format different from the first format if the viewer is of a second type different from the first type. The content in the instructional material may be associated with a viewer type attribute such that the content is displayed only if the viewer is of a type corresponding to the viewer type attribute. The content in the instructional material may also conform to a standard, such as a national standard set for an educational curriculum.

### FIELD OF THE INVENTION

The present invention relates generally to developing instructional materials from content stored in a database, and more particularly to a system and method for structuring a database to assist in the development of instructional materials tied to national standards and to provide audience dependent renderings of the instructional material.

### BACKGROUND OF THE INVENTION

In current systems for developing instructional materials, such as curricula in K-12 or presentations in a seminar, educators are generally limited to text books distributed to the schools by the various publishers. The de facto requirement of tying a curriculum to one of the limited number of textbooks available for each grade or content area restricts the structure and content that may be included in a curriculum. Moreover, this restriction may result in being forced to use material in the curriculum that is no longer in date.

Not only are there restrictions as to the structure and content, there are also potentially increased costs in this curriculum development system. To remain up to date with current content in a particular educational area, it is necessary to purchase new books every couple of years or so. For school districts with limited funding, it may be too expensive to keep their text books up to date. As a result, the purchase of new books may end up being delayed, which likely diminishes the educational experience of the students.

These problems relating to the development of educational curricula are not limited to K-12 schools. To a lesser extent, the problems also apply to college curricula. Moreover, the problems are also applicable to the development of instructional materials for other types of training, including business and technical training.

There are other problems with the development of instructional materials beyond keeping the content up to date and financial considerations. In some educational and training areas, the content of the material used in a class or for training may be highly regulated. The regulation of the content may require that the content conforms to some standard. For example, a national education standard may require that a topic for a particular grade level cover certain areas in order to conform with the standard.

Another problem relates to how the content of an instructional material or a curriculum is presented to the viewer. In a classroom setting, the teacher may desire to have the content with teacher notes that are not shown in the content presented to the students. Moreover, the teacher may be teaching the same curriculum to different levels of students or students in different grades, which may require the content to be displayed differently for each level or grade.

### SUMMARY OF THE INVENTION

Briefly, in a method consistent with the present invention for displaying an instructional material, the instructional material comprising a plurality of pieces of content, each piece of content being associated with a plurality of attributes, a request is received from a viewer to display the instructional material. The instructional material is displayed in a first format if the viewer is of a first type and is displayed in a second format different from the first format if the viewer is of a second type different from the first type.

In another aspect of the present invention, a viewer type attribute is associated with at least one piece of content in the instructional material, and the at least one piece of content is displayed only if the viewer is of a type corresponding to the viewer type attribute.

In yet another aspect of the present invention, a request is received for content stored in a database, the request including attribute information, and content is output from the database having associated attributes corresponding to the attribute information of the request. An indication is then received of which of the outputted content to include in the instructional material.

In another aspect of the invention, a method for developing an instructional material creates a piece of content to store in a database, and divides the content into separate portions. Attributes are associated with each of the portions, and the portions are stored in the database. The portions are included in the instructional material, wherein a viewer type attribute associated with at least one of the portions indicates the type of viewer for which the portion is to be displayed.

### BRIEF DESCRIPTION OF THE DRAWINGS

FIG. 1 is a block diagram of a content editing system consistent with the present invention.

FIG. 2 is a flow diagram of a content editing process consistent with the present invention.

FIG. 3 is a flow diagram of an editing process for the content editing process of FIG. 2.

FIG. 4 is a screen shot of an exemplary editor for the editing process of FIG. 3.

FIG. 5 is a screen shot of a graphical editing tool consistent with the present invention.

FIG. 6 is a flow diagram of an instructional material development process using the graphical editing tool of FIG. 5.

FIG. 7 is a flow diagram of a process for associating attributes of content for editing process of FIG. 3.

FIG. 8 is a flow diagram of a process for displaying content consistent with the present invention.

### DETAILED DESCRIPTION OF THE PREFERRED EMBODIMENT

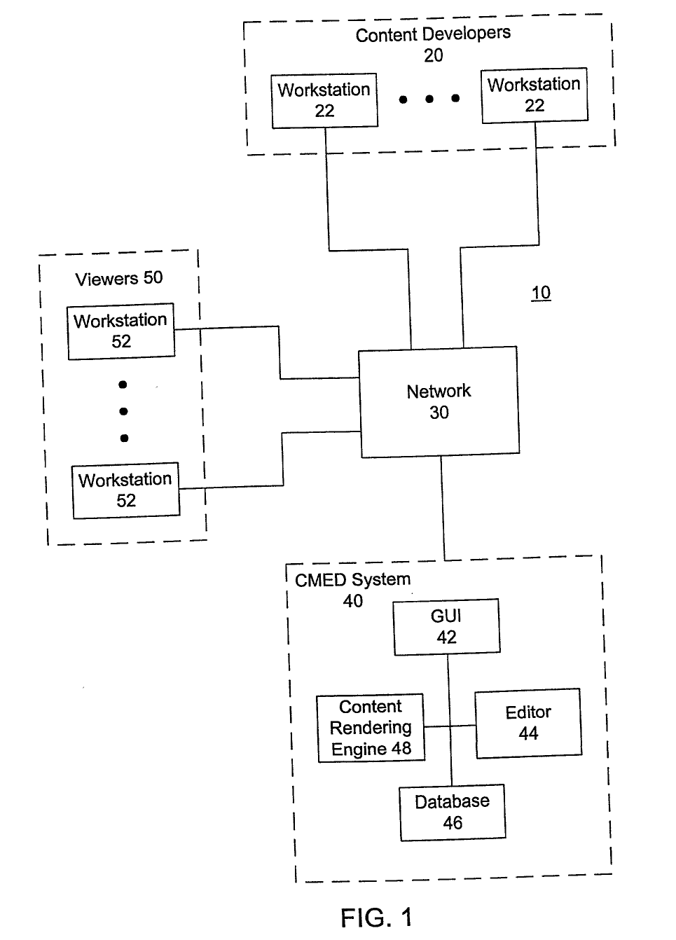

FIG. 1 is a block diagram of a system 10 consistent with the present invention. As shown in FIG. 1, the system 10 includes a group of content developers 20, a content management editing and delivery (CMED) system 40 and a group of viewers 50. Although the block of the content developers 20 and the block of the viewers 50 are shown as groups, each block may include just one content developer 20 and one viewer 50, respectively. The content developers 20, the CMED system 40 and the viewers 50 are all interconnected through a network 30.

Within the group of the content developers 20 are one or more workstations 22. Each of the workstations 22 may be implemented, for example, as a personal computer or other type of processing station. The workstations 22 may be part of a private network, such as a LAN or intranet. In addition, each of the workstations is coupled to the network 30, which may be implemented as a connection backbone to a plurality of different networks. The network 30 is preferably implemented as the Internet.

Like the group of content developers 20, the group of viewers 50 includes a plurality of workstations 52. The workstations 52 may implemented in the same manner as the workstations 22 and are each connected to the network 30. Although shown as being part of different groups, the workstations 22 and 52 may be part of the same or different private network. In addition, a single workstation may be part of both the group of the content developers 20 and the group of viewers 50.

The CMED system 40 includes a graphical user interface (GUI) 42, an editor 44, a database 46 and a content rendering engine 48. The CMED system 40 may be implemented, for example, as a server computer providing all of the functionality of the GUI 42, the editor 44, the database 46 and the content rendering engine 48. The functionality may be stored in a storage device in the server that is accessed by a processor to execute the functionality. Alternatively, the functionality of the GUI 42, the editor 44, the database 46 and the content rendering engine 48 may be distributed across multiple computers or multiple storage devices residing at one or more locations.

The GUI 42 provides an interface for the content developers 20 and the viewers 50 to use to access content stored in the database 46. The GUI may be implemented as a browser interface accessible to the content developers 20 and the viewers 50 via the Internet. The database 46 receives inputs through the GUI 42 and uses the inputs to access applicable content stored in the database 46. Content from the database 46 may be transformed for display to the content developer 20 or the viewer 50 by the content rendering engine 48. The content rendering engine 48 uses transforms, such as style sheets, to transform content from the database 46 into a viewable format. The style sheet is a set of rules for transformation of content into a desired form.

The editor 44 is a tool for the content developers 20 to edit content stored in the database 46. The editor 44 may also be used to edit content to be stored in the database 46 that has been imported from another location. The editor 44 is capable of editing content stored in a structure corresponding to the structure of the database 46. If the database 46 is implemented with XML (extensible markup language) structured content, the editor 44 may be implemented as XMetal 2.0, a product of SoftQuad Corporation.

The database 46 is preferably implemented using technology which is supportive of semi-structured documents, i.e., is supportive of both limited field retrieval as well as text indexing. The content in the database 46 may be defined structurally with XML, although other embedded metadata languages may be used. For a database of XML structured content, the database 46 may be implemented using the Structured Information Manager (SIM), a commercial product of the Royal Melbourne Institute of Technology. In an XML implementation, each piece of information in the database 46 is associated with a series of tags, referred to as metatags, and the structure of the data is interspersed with the content by embedding the metatags with the content. These tags generally provide attribute information, including identification and classification information for the content. For example, a piece of content may include tags identifying the author of the content, the title, the type of content, such as text or images, and any other relevant information. The tags are editable fields that may be referred to for identifying content applicable to an instructional material.

The database 46 includes a data model, which is a set of constructs that provides a structure of the information in the database. More specifically, the data model identifies what the context is of any particular data element. For example, the data model may identify information using classifications, such as classrooms have students, students are a subclass of people, or a curriculum has units, lessons, activities and resources, each of which has attributes. The data model provides structure in the database for information such as user registration information and data or content information, such as text, images, video or audio information.

One part of the data model is the document type definition or DTD. The DTD defines the structure and context of documents in the database 46. Documents include the data or content information stored in the database 46, including text, images, video or audio information. The DTD includes a document descriptor, which defines the way in which the elements of the document are structured. For example, a lesson has subsections, the subsections have headings, etc. The DTD also defines the tags associated with the content.

To display the information stored in the database 46, the content rendering engine 48 may use a style sheet having formatting rules for transforming content in the database 46 into a displayable format. The style sheet may be an XSLT (extensible style language transformation) style sheet, to transform the content in the database 46. The style sheet includes a set of rules that are read by the content rendering engine 48 for rendering of content stored in the database 46.

The database 46 may be distributed among one or more servers or computers located in the same or disparate locations. In operation, a query may be submitted to the database 46, and the query is applied to each part of the database 46, such as through a network. In response to the query, a single unified result is provided to the user who submitted the query. Queries to the database 46 may be effected using the Z39.50 query protocol adopted as a standard by ANSI. Queries are preferably made in a contextual format.

Distributing the database 46 allows a greater amount of content to be accessible and searchable. Moreover, the creator and owner of the content may hold on to the content and control the access to the content. For example, the database 46 may be distributed to include images from a nationally distributed magazine, which are stored in a server for the nationally distributed magazine. The images are preferably stored in a database having the same data model as the database 46 and conforming to the same query protocol, although the data model of the database for the nationally distributed magazine may be mapped to the data model of the database 46 if their data models are different. By distributing in this manner, the operator of the database 46 may selectively license content, such as the images from the nationally distributed magazine, and allow users of the database 46 to have access to that licensed content, but only need to submit a single query to search that licensed content.

The content developer 20 operating at the workstation 22 can develop instructional material by accessing the CMED system 40 via the network 30. Instructional material, consistent with the present invention, may be defined as a conglomeration of structured content that is developed with the assistance of the CMED system 40. After developing the instructional material, the content developer 20 may save the instructional material in the database 46. To view the instructional material developed by the content developer 20, the viewer 50 at the workstation 52 can access the CMED system 40 via the network 30, search the database for the desired instructional material, and have the instructional material displayed.

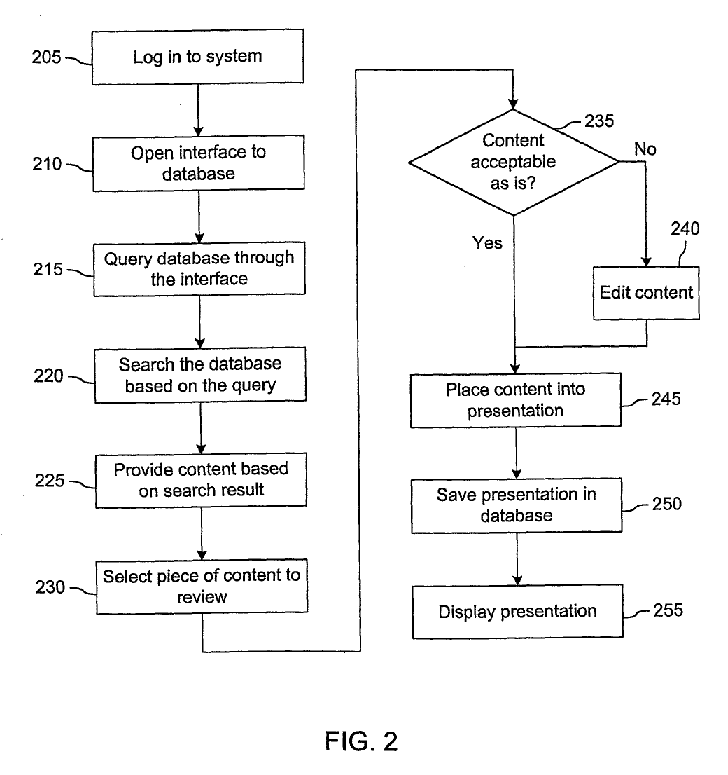

FIG. 2 is a flow diagram of a content editing and display process consistent with the present invention. As shown in FIG. 2, a content developer 20 first logs into the CMED system 40 (step 205). If the network 30 is implemented as the Internet, then the content developer 20 may access the CMED system 40 via the World Wide Web. In such an implementation, the process of logging on to the CMED system 40 preferably includes a secure connection. For example, the CMED system 40 may require all content developers 20 to first register with the CMED system 40 before the functionality of the CMED system 40 may be used. The registration may require a fee to be paid to the party providing the CMED system 40. Subsequent to registration, the content developer 20 may be required to provide a user identification and a password before access to the CMED system 40 is allowed. Alternatively, the network 30 may be implemented as a local private network that makes the CMED system 40 only accessible to content developers 20 that are part of the local private network.

After logging on to the CMED system 40, the content developer 20 opens an interface to the database 46 (step 210). The interface to the database 46 is preferably implemented as the GUI 42. If the content developer 20 is developing a new instructional material, then the content developer 20 makes a selection through the GUI 42. The selection may be effected through the use of menus that provide the content editor 20 with options that may be selected with a pointing device, such as a mouse, or with a keyboard. Alternatively, if the content developer 20 is editing a previously existing instructional material, then the content developer 20 may use the menus to select an instructional material to edit.

Whether developing a new instructional material or editing an existing instructional material, the content developer 20 may use content from the database 46 to include in the instructional material. To locate content applicable to the instructional material being developed, the content developer 20 issues a query to the database 46 through the GUI 42 (step 215). The query may be implemented in a variety of formats. In one format, the query may have a variety of different fields that the content developer 20 may fill in as search criteria. For example, the query may have fields for authors, titles, topics, dates, or any other field that is useful in classifying content stored in the database 46. Alternatively, the query may be implemented in a natural language format or a Boolean format. The content developer 20 may also specify search criteria, such as words in the same paragraph or the same sentence, or within so many words from each other. In addition, the content developer 20 may submit an entire section of text as the query, requesting that the CMED system 40 return samples of content in the database 46 which are similar to the section of text. The results of the search can come back with a Boolean matching or with a relevancy ranking.

After completing the query, the query is submitted to the database 46. The query is used to search the database 46 for applicable content (step 220). To identify the applicable content, the database 46 analyzes the submitted query and determines what type of content corresponds to the submitted query. If the database 46 is implemented with XML structured content, the database 46 may search for content associated with tags corresponding to the content of the query. For example, if the query has fields for author and title that are filled-in in the query, the database 46 may identify content in the database 46 that has tags corresponding to the author and title identified in the query. In addition to searching the tags, the database 46 may search the content itself for terms corresponding to the information in the query. In the example of the title and author, the database 46 may identify text, such as articles, that refer to the title and author identified in the query.

The content in the database 46 that is identified in response to the search query is then provided to the content developer 20 through the GUI 42 (step 225). The content may be text, images, audio or video data. The identified content may be presented in a list in a window of the GUI 42, with each piece of identified content having some form of associated information describing the piece of content. For example, a picture of a president may be listed as “Picture of George Washington.” Each piece of identified content may also be associated with an icon that the content developer 20 can click on to view the piece of content and its associated attributes or tags.

From the list of content, the content developer 20 selects a piece of content to review to determine whether to include it in the instructional material (step 230). To review the content, the content developer 20 selects one of the pieces of content from the list, such as with a mouse click. The piece of content may be selected by clicking on the icon associated with the piece of content. Reviewing the content gives the content developer 20 an opportunity to see the content before deciding whether or not the content is acceptable for the instructional material. The opportunity to review the content allows the content developer 20 to determine if the selected content is acceptable as is for the instructional material (step 235).

If the selected content is not acceptable as is, the content developer 20 may edit the content using the editor 44 (step 240). If the database 46 is implemented with XML structured content, the content developer 20 can change both the tags associated with the content as well as the content itself. For example, if a piece of text is changed by the content developer 20, the content may be saved as a new version in the database 46 with the tag for the author changed to the content developer 20. The tags associated with the content may be displayed to the content developer as a series of fields, each field corresponding to one of the tags that may be associated with the content. To change the tags, the content developer may simply change the information in the field of the tag.

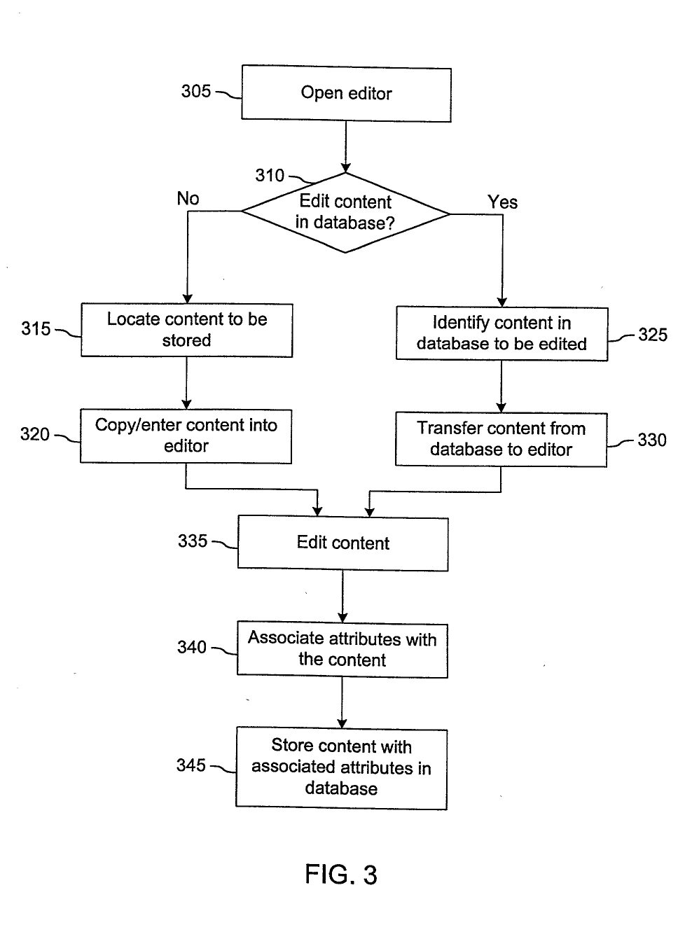

FIG. 3 is a flow diagram of an editing process for the content editing process of FIG. 2. As shown in FIG. 3, the first step is to open the editor 44 (step 305). To open the editor 44, the content developer 20 may open the editor 44 with a mouse click using menus presented in the GUI 42. The step of opening the editor 44 may be done automatically by clicking on a piece of content stored in the database 46, as described above. After opening the editor 44, the content developer 20 decides whether or not to edit content in the database 46 (step 310).

If the content developer 20 is not going to edit content in the database 46, the content developer 20 locates content to be edited and stored in the database 46 (step 315). The content to be edited can be located in a variety of locations. For example, the content developer 20 can identify content located on a disk or hard drive of the workstation 22, content located on a content management system of a local network that includes the workstation 22, content from a web site located via the Internet, or content from any other location that the content developer 20 wishes to edit and store in the database 46. The content itself may be text, images, video data or audio data. The identified content is then copied into the editor 44 (step 320). It is also possible for the content developer 20 to simply open the editor 44 and enter content, such as text, with an input device, such as a keyboard.

If the content developer 20 is going to edit content in the database 46, the content developer 20 first identifies which piece of content in the database 46 to edit (step 325). The content to be edited may be a piece of content selected by the content developer 20 to be included in the instructional material. Alternatively, after opening the editor 44, the content developer may open an interface to the database 46, as described above, and submit a query to the database 46 to identify a piece of content to edit. In response to the submitted query, the database 46 parses the query, searches the database 46 for content corresponding to the query, and provides a listing of the content found to correspond to the query. The content developer 20 identifies which piece of content in the list to edit. The identified piece of content is then transferred to the editor 44 (step 330).

With the content present in the editor 44, the content developer 20 may edit the content as desired (step 335). The method in which the content is edited may depend on the type of content. For example, the method for editing text may be different than the method for editing images. To facilitate the editing of different types of content, the editor 44 may include functionality equivalent to editors for specific types of content. For example, the editor 44 may include word processing editing capabilities, such as provided by Microsoft Word, and image editing capabilities, such as provided by Adobe PhotoShop.

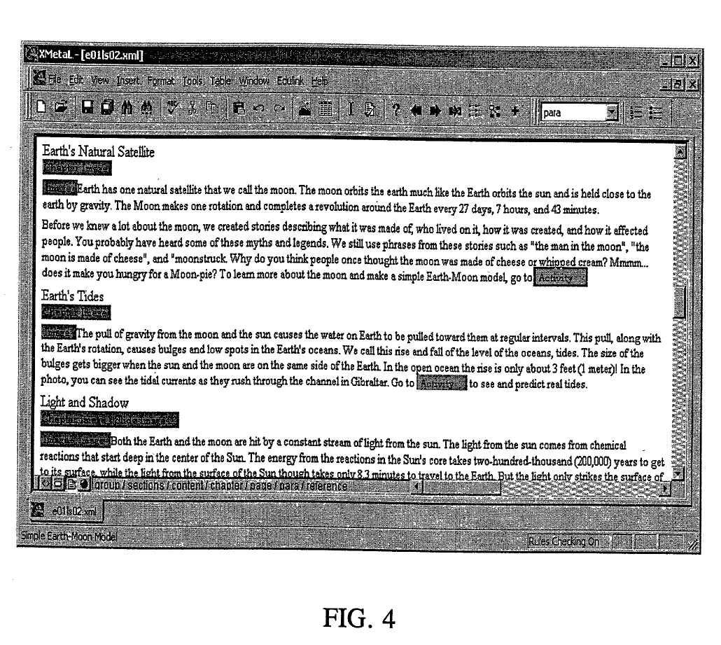

FIG. 4 is a screen shot of a piece of content being edited with the editor 44. As shown in FIG. 4, the editor 44 includes the functionality of XMetal 2.0, which is used to edit XML structured content. In this screen shot, the content includes a series of subsection headings: Earth's Natural Satellite; Earth's Tides; and Light and Shadow. There are also a series of images, three of which are chapter images and one of which is a slide image. The identification of an image as a chapter image or a slide image is used by the 48 to determine how the image will be displayed. In addition to the images and subsection headings, there are links to activities.

In this setting, the content developer may change the text, change the images, or change the activities linked to the content. After making the changes, the changes are saved in the database 46. It is not necessary to save the entire piece of content as a new piece of content in the database 46. Rather, it is possible to merely save the changes to the original piece of content, while including a link between the changes and the original piece of content.

In addition to editing the content, the content developer 20 may associate attributes with the content (step 340). For an XML implementation, the attributes may be stored as tags that are associated with the content. Associating attributes with the content may include adding attributes to the content, as well as editing the attributes already associated with the content. For example, the content developer 20 may add a caption attribute to an image describing what the image is or may change a date attribute to reflect that the image has been edited on that date. As will be discussed in more detail below, the content developer 20 may associate special attributes with the content, which assist the content developer 20 in developing instructional materials appropriate to the viewer 50 or viewing audience of the instructional material, as well as in developing instructional materials for which the content conforms with a particular standard. After editing the content and associating attributes with the content, the edited content and associated tags are stored in the database 46 (step 345).

Returning to FIG. 2, after editing the content or leaving it as is, the content is then placed in the instructional material (step 245). If the content developer 20 has completed the instructional material, or if the content developer 20 wishes to save their work and complete it later, the instructional material may then be saved in the database 46 (step 250). The saved instructional material includes information regarding all of the different content included in the instructional material. In addition, it may have information regarding the author of the instructional material, when it was created, who has access to it, and any other information that may be useful for identifying the instructional material, such as a title.

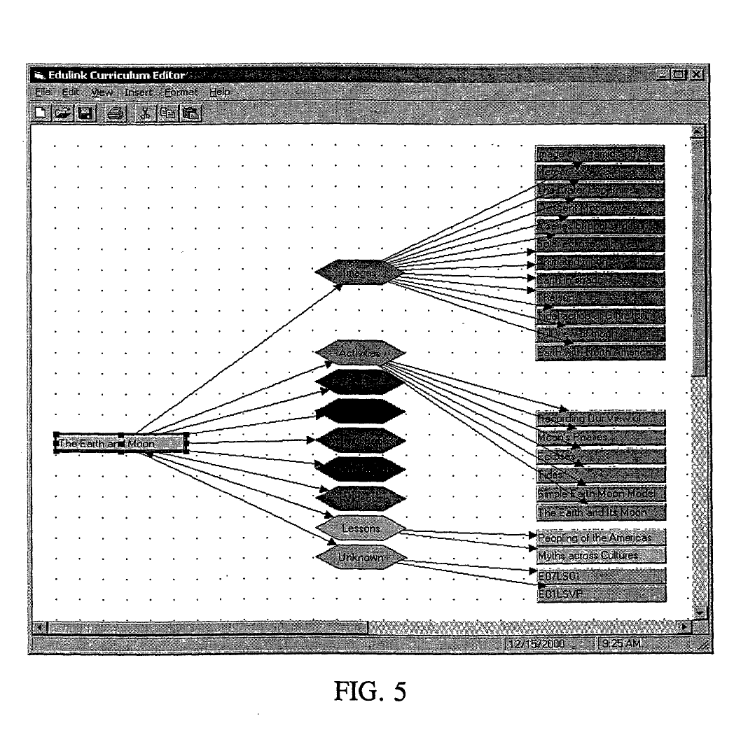

When creating the instructional material, the content developer may use a graphical editing tool to help facilitate the design and structure of the instructional material. FIG. 5 is a screen shot showing a graphical structure of instructional material developed by a content developer 20. In the example of FIG. 5, the content developer has developed instructional material entitled “The Earth and Moon.” Linked to the instructional material are a plurality of types of content that may be included in the instructional material. The types of content include images, activities, web sites, audio, activity books, videos, lessons, and unknown (or miscellaneous). These content types are merely exemplary, and other content types or classifications may also be included.

Linked to each type of content are the specific pieces of content from the database 46 that are included in the instructional material. For example, the lessons include “Peopling of the Americas” and Myths Across Cultures.” The “Peopling of the Americas” and “Myths Across Cultures” may be textual materials stored in the database 46. These textual materials may also include or be linked to other types of content, such as images or activities.

The view shown in FIG. 5 is one example of the different inter-relationships between the content, the different types of content, and the instructional material. Other inter-relationships may also be shown. For example, the content developer 20 may request that the inter-relationships between the lessons and the other types of content be shown. In response to this request, the structure in FIG. 5 would show how the lessons are related or linked to any images or activities included in that lesson.

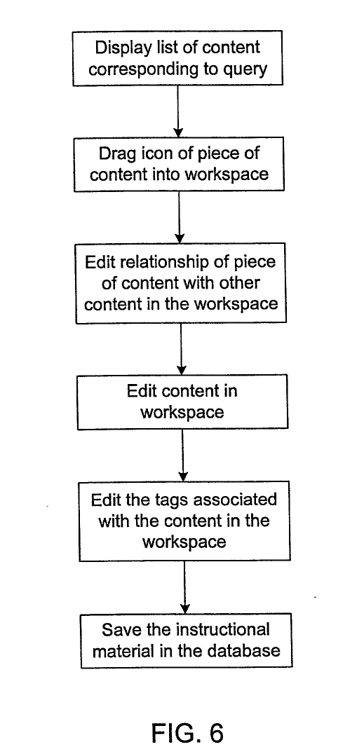

In addition to graphically displaying the various inter-relationships of the content and content types of the instructional material, the content developer 20 may use the graphical tool to add and edit the structure of the instructional material. FIG. 6 is a flow diagram of an instructional material development process using the graphical editing consistent with the present invention. As described above, after submitting a query, a list of content corresponding to the query is displayed to the content developer 20 (step 610). Each piece of content in the list may have a corresponding icon.

To include a piece of content from the list in the instructional material, the content developer 20 drags the icon into a workspace provided by the graphical editing tool for the instructional material being developed (step 620). To drag the icon into the workspace, the content developer 20 can click on the icon corresponding to a selected piece of content with a mouse and drag the icon into the workspace.

After placing the icon in the workspace, the content developer 20 may edit the relationship or placement of the content corresponding to the icon with other content in the workspace (step 630). For example, the content developer 20 may want to have an image which has just been placed in the workspace to be included in a lesson. To do so, the content developer 20 creates a link between the icon for the image and the icon for the lesson. The link may be created by placing the icon for the image over the icon for the lesson. Alternatively, the content developer 20 may create the link by clicking on the icon for the image, and then use a feature from the graphical editing tool that allows the content developer 20 to draw the link between the icons.

After creating a relationship between pieces of content in the workspace, the content developer 20 may then edit a piece of content in the workspace (step 640). As described above, the content developer 20 may edit a piece of content, such as a lesson, by double clicking on the icon corresponding to the lesson, so that it appears in the editor 44, such as shown in FIG. 4. In addition to displaying the content of the lesson, the editor 44 displays any content that has been linked to the lesson, such as the just linked image. With the editor 44 open, the content developer 20 may edit the lesson and place the image just linked to the lesson at the specific location desired by the content developer 20.

In addition to editing the content, the relationships of the content, and the placement of the content, the content developer 20 may use the graphically displayed structure of the instructional material to edit the tags associated with the content (step 650). To edit the tags associated with a piece of content in the workspace, the content developer 20 may right click on the icon corresponding to the piece of content, which displays a menu from which the content developer 20 can select to view and edit the tags of the piece of content. In response to the selection, a window is displayed of all of the tags that are associated with the piece of content. The window may include a series of fields, each field corresponding to a respective one of the tags. The content developer 20 may change or edit any of these fields as desired.

The content developer 20 can also edit tags for the piece of content with the content displayed in the editor 44, such as shown in FIG. 4. With the content displayed in the editor 44, the content developer 20 may associate tags with particular portions of the content. For example, the content developer 20 may highlight a particular paragraph of the content and associate a viewer type attribute tag for the highlighted content.

When the content developer 20 has finished developing the instructional material, the content developer 20 saves the instructional material in the database 46 (step 660). The content developer 20 may designate who has access to the saved instructional material. For example, the content developer 20 may be an instructor who desires to have each of the students in the class to have access to the instructional material. Alternatively, the content developer may allow anyone registered in the CMED system 40 to have access to the instructional material.

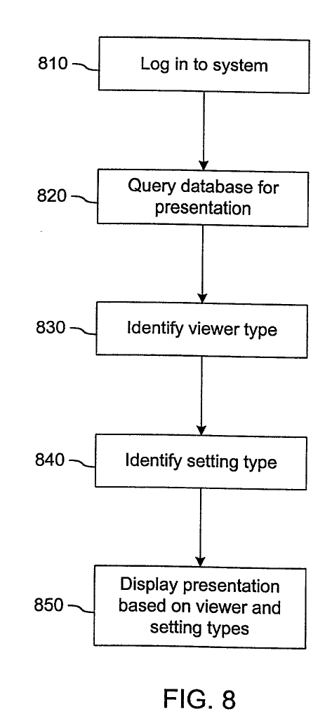

Returning to FIG. 2, after the instructional material has been completed and saved in the database 46, the viewer 50 may log onto the CMED system 40, select the desired instructional material through the GUI 42 and have the selected instructional material displayed (step 255). The content of the instructional material is displayed by transforming the content with the content rendering engine 48. If the database 46 is implemented with XML structured content, then the content making up the instructional material may be transformed by the content rendering engine 48 using an XSLT style sheet. The XSLT style sheet uses attribute information associated with the content to determine how to display the content. The display of the instructional material will be further described with respect to FIG. 8, discussed below.

As mentioned above, in the system 10, it is possible to alter the display of the instructional material based on the type of the viewer 50 as well as the setting in which the instructional material is being viewed. For example, an instructional material may appear in a particular format to the viewer 50 of a particular type, such as a student, but appear in a different format to the viewer 50 of a different type, such as a teacher. It is also possible in the system 10 to ensure that the content of the instructional material conforms to a particular standard. For example, if the instructional material is for an educational curriculum, the system 10 can assist the content developer 20 in determining if the content conforms to a standard associated with the educational curriculum being developed by the content developer 20. The system 10 may also alter the display of the instructional material depending upon the setting in which it is being viewed, such as on an overhead to a large audience or to a single viewer 50 on a computer monitor.

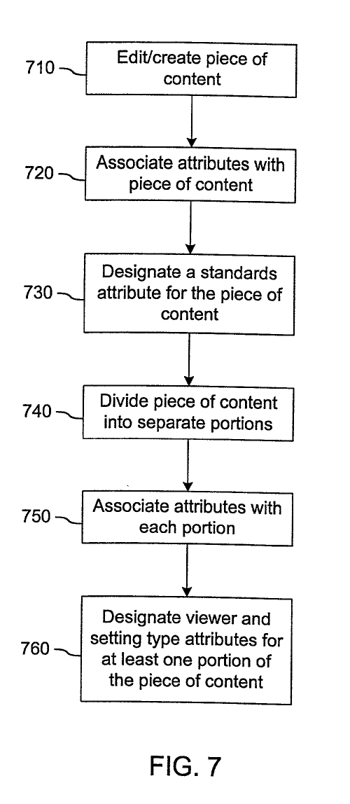

FIG. 7 is a flow diagram of a process for associating attributes with the content for the editing process of FIG. 3. With the process of FIG. 7, it is possible to edit content that enables an instructional material to be displayed differently to different types of the viewers 50, different viewer settings and that ensures that content within an instructional material conforms to a particular standard. As shown in FIG. 7, the content developer 20 first edits or creates a piece of content using the editor 44 (step 710). The process for editing or creating a piece of content using the editor 44 is discussed above with respect to FIG. 3.

As also discussed above with respect to FIG. 3, the content developer 20 may also associate and edit attribute information corresponding to a piece of content (step 720 in FIG. 7). The attribute information corresponding to the piece of content provides identification and classification information for the content, such as the author of the content, the title, the type of content, such as text or images, and any other relevant information.

Among the relevant information that may be included in the attribute information is a standards attribute that is designated by the content developer 20 for the piece of content (step 730). The standards attribute identifies a standard to which the piece of content conforms. The standard may be a national educational standard for a curriculum for grades K-12 or college, a standard for content used for training, such as for training in a computer language, or any other type of standard that identifies what content is acceptable. When developing an instructional material, the content developer 20 can refer to the standards attribute to determine whether or not the content in the instructional material conforms to a standard. For example, if the content developer 20 is developing a curriculum for a high school history class, the content developer can search for material that has a standards attribute for the standard applicable to the class, and use the content resulting from the search to form the curriculum.

In addition to associating attribute information with a piece of content, including a standards attribute, it is possible to have attributes only apply to specific portions of the piece of content. To do so, the content developer 20 first divides the piece of content into separate portions (step 740). The content developer 20 may divide the content by selecting different sections of the content to divide into separate portions. For example, if the content is text, the content developer 20 could divide the content by paragraphs or by subsection headings, marking each paragraph or heading as being a separate portion. Then, the content developer 20 associates attributes that are only applicable to a particular portion of the piece of content (step 750). For example, if the content developer 20 edits the text of an article prepared by another one of the content developers 20, the content developer 20 might change just one paragraph and want to have attribute information applied to the changed paragraph only. The attribute information for the changed paragraph may indicate the identity of the content developer 20 changing the paragraph and when the paragraph was changed.

The content developer 20 may also designate viewer type attributes for one or more portions of the piece of content (step 760). The viewer type attribute indicates the types of viewers for which the content is applicable and viewable by identifying classes of viewers for which the content associated with the viewer type attribute is to be shown. For example, in an educational or training setting, the classes of viewers may be among teachers, students, parents and administrators or among lecturers and attendees. Other classes of viewers may be based on the different education, grade or age levels of the viewers, the different geographic locations of the viewers, the different occupations of the viewers, or any other type of viewer classification. The viewer type attribute may be used in any situation in which the content developer 20 wants the instructional material to appear in one format for one class of viewers and in a different format for a different class of viewers.

The setting type attribute indicates the types of settings for which the content is applicable and viewable. The setting relates to the scope of the audience viewing the content. For example, the instructional material may be displayed to many viewers 50, a few viewer 50 or a single viewer 50. With respect to a classroom, a teacher may want to have part of the instructional material displayed to the entire class with an overhead, have students view the instructional material in groups of a few, or have each student view the instructional material individually.

In these different settings, it may be desirable to have the instructional material displayed in different formats depending on the setting. For example, when displaying to many viewers, such as all of the students in a classroom with an overhead, it may be desirable to have more images or graphics displayed instead of text. On the other hand, when displaying to a single viewer, such as each student at their own computer, it may be desirable to have more text and fewer images or graphics displayed.

To have the instructional material displayed in these different formats depending upon the setting, the rendering style sheet of the content rendering engine 48 determines which elements are displayed and how the layout will be done. The style sheet rules are written to utilize document structure and metadata, i.e., the XML tags, in such a way that they are optimal for the setting. The style sheet used by the content rendering engine 48 is chosen based on the setting. For example, for a one to many setting, like a classroom with a single big screen, body text is minimized, images are maximized, and section heading may be used as speaking prompts for the instructor. In contrast, for a many to many setting (analogous to a one to one setting), body text is maximized, images are either in-line or minimized, and section headings are in-line.

There are no specific setting attributes embedded in the content. Rather, with the setting determined at the display time based on a selection by the viewer 50, the content rendering engine 48 recognizes the type of the content included in the instructional material, such as text and images, and displays the content according to the setting as described above, using the appropriate style sheet.

FIG. 8 is a flow diagram of a process for displaying content consistent with the present invention, which illustrates the effect of the viewer type attribute. As shown in FIG. 8, the viewer 50 first logs into the system 10 (step 810). If the viewer 50 has not previously logged into the system 10, the viewer 50 may be required to register with the system 10. After registering with the CMED system 40, a record of the viewer 50 is stored in the database 46. The record of the viewer 50 includes any identification information, including viewer type, of the viewer 50.

If the CMED system 40 is implemented as a server accessible via the Internet, the viewer 50 may log onto the CMED system 40 through a browser to view the instructional material located in the CMED system 40. When the viewer 50 has logged on to the CMED system 40, a desktop may be displayed to the viewer 50. The desktop may display which instructional materials have been assigned or are accessible to the viewer 50. For example, an instructor may mark a particular instructional material as an assignment for each of the students in the instructor's class, and the students would then see the assigned instructional material when they logged on the CMED system 40.

To display the appropriate desktop, the viewer 50 first logs on to the CMED system 40, then the CMED system 40 refers to the database 46, identifies the record of the viewer 50, and uses the information in the record of the viewer 50 to display the appropriate desktop to the viewer 50. The viewer 50 may then click on an instructional material shown on the desktop to have that instructional material displayed.

If after the viewer 50 is logged in and registered there are no instructional materials shown on the desktop, the viewer 50 may open an interface to the database 46 and submit a query to locate a desired instructional material (step 820). In response to a the query, a list of different instructional materials corresponding to the query is presented to the viewer 50. For example, if the viewer 50 is looking for an instructional material that is used in a computer training seminar being taken by the viewer 50, the viewer 50 may submit a query providing specifics about the seminar, such as who the lecturer is, the topic of the seminar, and any other relevant information that may be used to identify the desired instructional material. The viewer 50 then selects which of the instructional materials to be displayed.

Before the instructional material is displayed to the viewer 50, the viewer type is identified (step 830). The viewer type corresponds to a class of viewers that includes the viewer 50. For example, with respect to the computer training seminar, the viewer type may be lecturer or attendee, beginner or advanced, or some combination thereof. The viewer type may be identified from the record corresponding to the viewer 50 that is stored in the database 46.

In addition to the viewer type, a setting type is identified (step 840). The setting type corresponds to manner in which the instructional material is going to be displayed. For example, with respect to the computer training seminar, the setting type may be one to many, one to a few, or one to one. A one to many setting may be, for example, when using an overhead to display the instructional material to the entire class, whereas a one to one setting may be, for example, displaying the instructional material to each attendee at their own computer screen. The viewer 50 may provide an indication to the CMED system 40 regarding what the setting is for the current session, i.e., one to many, one to few, or one to one.

Based on the viewer type and the setting type, the instructional material is displayed to the viewer 50 (step 850). The format of the instructional material that is displayed to the viewer 50 may be different depending upon the viewer type and the setting type. In the example of the computer training seminar, the instructional material may be displayed in one format for the lecturer, but in a different format for the attendee. Similarly, the instructional material may be displayed in different formats for beginner-level viewers versus advanced-level viewers. To have the instructional material displayed in different formats for the different types of viewers, the content developer 20 includes viewer type attributes in the instructional material. The viewer type attributes indicate what portions of the content in the instructional material to display to the viewer 50. In particular, if the viewer type attribute of a portion of the content matches the viewer type of the viewer 50, the portion of the content is displayed. However, if the viewer type attribute of the portion of the content does not match the viewer type of the viewer 50, the portion of the content is not displayed.

In the example of the computer training seminar with respect to setting type, the instructional material may be displayed in one format when displayed by overhead to each of the attendees, i.e., one to many, and in a different format when displayed to each of the attendees at their respective computers, i.e. one to one. To have the instructional material displayed in different formats for the different types of settings, a style sheet in the content rendering engine 48 is used that corresponds to the particular setting. The rendering style sheet is different for each of the different types of settings.

The following hypothetical illustrates an example of how the viewer type, setting type, and standards attribute may be used in conjunction with the system 10, consistent with the present invention. In the hypothetical, the content developer 20 is developing an instructional material that is to be used for a high school history class to be taught to both a ninth grade level and a tenth grade level class. The history class relates to American history and is an instructional material to be displayed in a one to one setting, i.e., individually to each student and to the teacher.

The first step for the content developer 20, as shown in FIG. 2, is to log into he system 10 and open an interface to the database 46 through the GUI 42 to identify content to include in the instructional material. Since the instructional material relates to American history, the content developer 20 would submit a query with respect to a relevant topic, such as the revolutionary war. The query may include requests for particular time periods, important leading figures and locations, and other relevant information. In addition, the content developer 20 may include an indication as to the national standard to which the content must conform.

In response to the submission of the query, the database 46 parses the query and identifies content in the database 46 that corresponds to the submitted query. If the submitted query includes a national standard, then only content having a standards attribute corresponding to the national standard in the query may be identified. The identified content is presented as a list to the content developer 20 through the GUI 42. Each piece of identified content includes a corresponding icon, which may be used in conjunction with the graphical editing tool described above to facilitate the editing of the content and structuring of the instructional material. The content developer 20 then selects a piece of content to review to determine whether to include it in the instructional material and whether to edit the content.

If the content developer 20 decides to edit the selected content, then the selected content is transferred to the editor 44. The content developer can transfer the selected content to the editor 44 by clicking on the icon associated with the selected content. Using the editor 44, the content developer 20 can change the content and its associated attributes. For example, if the content is an article, the content developer 20 may edit some of the text of the article or even add new content to the article. The content developer 20 may also divide the article into separate portions, such as by paragraph, and associate specific attributes for those portions, including a viewer type attribute.

The editing of the article enables to the content developer 20 to create a format for the ninth grade level class and a different format for the tenth grade level class. For example, the content developer 20 may edit a paragraph of the article to be at a ninth grade level and create the same paragraph at a tenth grade level. For the ninth grade level paragraph, the content developer 20 may associate a viewer type attribute indicating that the paragraph is for a ninth grade level student. Similarly, the content developer 20 may associate a viewer type attribute with the tenth grade level paragraph indicating that the paragraph is for a tenth grade level student.

In addition to editing the article for the different grade levels, the content developer 20 may add comments to different portions of the articles that may be used by the teacher of the class, i.e., teaching notes. To ensure that the teaching notes are only displayed to the teacher of the instructional material that includes the article, the content developer 20 may associate a viewer type attribute with the teaching notes indicating that the teaching notes are for the teacher, or more specifically, for the teacher of the ninth or tenth grade level.

When the development of the instructional material is complete, the content developer 20 saves the instructional material in the database 46. By using the standards attribute as a search criterion, the content developer 20 can ensure that the content of the instructional material conforms to the national standard applicable to the instructional material. In the hypothetical, the national standard would cover what is acceptable for a high school class on American history. Also, even though the instructional material is to be displayed in different formats for the different types of viewers and in different settings, only a single version of the instructional material is stored in the database 46. By using the viewer type attributes for various portions of the content of the instructional material and accommodating different settings, a single version of the instructional material can be displayed in a different format for each type of viewer and each type of setting.

To use this instructional material, the viewer 50 logs into the system 10 and selects the instructional material shown on the desktop of the viewer 50. Alternatively, the viewer 50 can open an interface to the database 46 through the GUI 42 and submit a query to the database 46, which is parsed by the database 46 to identify instructional materials corresponding to the submitted query. The viewer 50 then selects an instructional material from the list of instructional materials resulting from the search of the database 46. The selected instructional material is displayed to the viewer 50 depending on the viewer type and the setting type. In the hypothetical, if the viewer 50 is a ninth grade student, then the instructional material would be displayed with the content having its viewer type attribute set to ninth grade level student. Alternatively, if the viewer 50 is the teacher, then the instructional material would be displayed with the content having its viewer type attribute set to teacher, such as teacher notes. Also, if the content is being displayed to the students and teacher individually, then the instructional material would be displayed using a style sheet of the content rendering engine 48, which displays the content in accordance with the one to one setting, such as by maximizing the content while minimizing images.

The foregoing description of a preferred embodiment of the invention has been presented for purposes of illustration and description. It is not intended to be exhaustive or to limit the invention to the precise form disclosed, and modifications and variations are possible in light in the above teachings or may be acquired from practice of the invention. The embodiment was chosen and described in order to explain the principles of the invention and as practical application to enable one skilled in the art to utilize the invention in various embodiments and with various modifications are suited to the particular use contemplated. It is intended that the scope of the invention be defined by the claims appended hereto and their equivalents.

What is claimed is:

1. A method for displaying an instructional material, the instructional material comprising a plurality of pieces of content, each piece of content being associated with a plurality of attributes, the method comprising:
receiving a request from a viewer to display the instructional material; and
displaying the instructional material in a first format if the viewer is of a first type and displaying the instructional material in a second format different from the first format if the viewer is of a second type different from the first type.

2. A method according to claim 1, further comprising:
receiving an indication of the type of viewer; and
displaying the instructional material in the first format or the second format based on the received indication.

3. A method according to claim 1, further comprising:
receiving a request for content stored in a database, the request including attribute information;
outputting content from the database having associated attributes corresponding to the attribute information of the request; and
receiving an indication of which of the outputted content to include in the instructional material.

4. A method according to claim 3, wherein receiving a request includes receiving a request for content that conforms to a standard.

5. A method according to claim 4, wherein the standard corresponds to a national standard set for an educational curriculum.

6. A method according to claim 1, wherein the type of viewer is either a student or a teacher.

7. A method for according to claim 1, further comprising:
storing the pieces of content in a database, at least one piece of content being divided into separate portions,
wherein at least one portion is associated with a viewer type attribute indicating the type of viewer for which the portion is to be displayed.

8. A method according to claim 7, wherein the at least one portion is included in the instructional material.

9. A method according to claim 8, further comprising:
receiving an indication of the type of viewer; and
displaying the instructional material with the at least one portion if the type of viewer corresponds to the viewer type attribute associated with the portion.

10. A method for displaying an instructional material, the instructional material comprising a plurality of pieces of content, each piece of content being associated with a plurality of attributes, the method comprising:
receiving a request from a viewer to display the instructional material; and
displaying the instructional material in a first format if the display request is for a setting of a first type and displaying the instructional material in a second format different from the first format if the display request is for a setting of a second type different from the first type.

11. A method according to claim 10, wherein the type of setting relates to the size of the audience viewing the instructional material.

12. A method according to claim 11, wherein the type of setting is one to many, one to few or one to one.

13. A method according to claim 12, wherein the instructional material is displayed with more images and less text for a one to many setting type than for a one to few or a one to one setting type.

14. A method according to claim 10, further comprising:
receiving an indication of the type of setting; and
displaying the instructional material in either the first format or the second format based on the received indication.

15. A method for developing instructional material, the instructional material comprising a plurality of pieces of content, each piece of content being associated with a plurality of attributes, each piece of content and associated attributes being stored in a database, the method comprising:
receiving a search request, the search request including one or more terms;
displaying a list of icons associated with pieces of content in the database corresponding to the terms of the search request;
placing an icon from the displayed list in a workspace window in response to a first received indication, the workspace window displaying icons of pieces of content included in the instructional material; and
creating a relationship for the icon placed in the workspace window with at least one other icon in the workspace window in response to a second received indication.

16. A method according to claim 15, further comprising:
displaying a piece of content in an editing window in response to the selection of an icon corresponding to the piece of content in the workspace window.

17. A method according to claim 16, further comprising:
changing the piece of content displayed in the editing window in response to a third received indication.

18. A method according to claim 16, wherein the displaying includes displaying at least one other piece of content having a relationship with the piece of content corresponding to the selected icon.

19. A method according to claim 15, further comprising:
displaying the plurality of attributes associated with a piece of content in an editing window in response to the selection of an icon corresponding to the piece of content in the workspace window.

20. A method according to claim 19, further comprising:
changing at least one of the plurality of attributes in response to a third received indication.

21. A method according to claim 15, wherein the creating of a relationship includes determining a placement of the piece of content corresponding to the icon placed in the workspace window relative to another piece of content included in the instructional material.

22. A computer readable medium operable on a computer system for displaying an instructional material, the instructional material comprising a plurality of pieces of content, each piece of content being associated with a plurality of attributes, the computer readable medium configured to:
receive a request from a viewer to display the instructional material; and
display the instructional material in a first format if the viewer is of a first type and displaying the instructional material in a second format different from the first format if the viewer is of a second type different from the first type.

23. A computer readable medium according to claim 22, further configured to:
receive an indication of the type of viewer; and
display the instructional material in the first format or the second format based on the received indication.

24. A computer readable medium according to claim 22, further configured to:
receive a request for content stored in a database, the request including attribute information;
output content from the database having associated attributes corresponding to the attribute information of the request; and
receive an indication of which of the outputted content to include in the instructional material.

25. A computer readable medium according to claim 24, further configured to:
receive a request for content that conforms to a standard.

26. A computer readable medium according to claim 25, wherein the standard corresponds to a national standard set for an educational curriculum.

27. A computer readable medium according to claim 22, wherein the type of viewer is either a student or a teacher.

28. A computer readable medium for according to claim 22, further configured to:
store the pieces of content in a database, at least one piece of content being divided into separate portions,
wherein at least one portion is associated with a viewer type attribute indicating the type of viewer for which the portion is to be displayed.

29. A computer readable medium according to claim 28, wherein the at least one portion is included in the instructional material.

30. A computer readable medium according to claim 29, further configured to:
receive an indication of the type of viewer; and
display the instructional material with the at least one portion if the type of viewer corresponds to the viewer type attribute associated with the portion.

31. A computer readable medium operable on a computer system for displaying an instructional material, the instructional material comprising a plurality of pieces of content, each piece of content being associated with a plurality of attributes, the computer readable medium configured to:
receive a request from a viewer to display the instructional material; and
display the instructional material in a first format if the display request is for a setting of a first type and displaying the instructional material in a second format different from the first format if the display request is for a setting of a second type different from the first type.

32. A computer readable medium according to claim 31, wherein the type of setting relates to the size of the audience viewing the instructional material.

33. A computer readable medium according to claim 32, wherein the type of setting is one to many, one to few or one to one.

34. A computer readable medium according to claim 33, wherein the instructional material is displayed with more images and less text for a one to many setting type than for a one to few or a one to one setting type.

35. A computer readable medium according to claim 31, further configured to:
receive an indication of the type of setting; and
display the instructional material in either the first format or the second format based on the received indication.

36. A computer readable medium operable on a computer system for developing instructional material, the instructional material comprising a plurality of pieces of content, each piece of content being associated with a plurality of attributes, each piece of content and associated attributes being stored in a database, the computer readable medium configured to:
receive a search request, the search request including one or more terms;
display a list of icons associated with pieces of content in the database corresponding to the terms of the search request;
place an icon from the displayed list in a workspace window in response to a first received indication, the workspace window displaying icons of pieces of content included in the instructional material; and
create a relationship for the icon placed in the workspace window with at least one other icon in the workspace window in response to a second received indication.

37. A computer readable medium according to claim 36, further configured to:
display a piece of content in an editing window in response to the selection of an icon corresponding to the piece of content in the workspace window.

38. A computer readable medium according to claim 37, further configured to:
change the piece of content displayed in the editing window in response to a third received indication.

39. A computer readable medium according to claim 37, further configured to:
display at least one other piece of content having a relationship with the piece of content corresponding to the selected icon.

40. A computer readable medium according to claim 36, further configured to:
display the plurality of attributes associated with a piece of content in an editing window in response to the selection of an icon corresponding to the piece of content in the workspace window.

41. A computer readable medium according to claim 40, further configured to:
change at least one of the plurality of attributes in response to a third received indication.

42. A computer readable medium according to claim 36, further configured to:
determine a placement of the piece of content corresponding to the icon placed in the workspace window relative to another piece of content included in the instructional material.

43. A computer system for displaying an instructional material, the instructional material comprising a plurality of pieces of content, each piece of content being associated with a plurality of attributes, the computer system comprising:
a processor; and
a memory which stores a plurality of instructions executed by the processor, the plurality of instructions configured to:
receive a request from a viewer to display the instructional material; and
display the instructional material in a first format if the viewer is of a first type and displaying the instructional material in a second format different from the first format if the viewer is of a second type different from the first type.

44. A computer system according to claim 43, the memory further comprising instructions configured to:
receive an indication of the type of viewer; and
display the instructional material in the first format or the second format based on the received indication.

45. A computer system according to claim 43, the memory further comprising instructions configured to:
receive a request for content stored in a database, the request including attribute information;
output content from the database having associated attributes corresponding to the attribute information of the request; and
receive an indication of which of the outputted content to include in the instructional material.

46. A computer system according to claim 45, the memory further comprising an instruction configured to:
receive a request for content that conforms to a standard.

47. A computer system according to claim 46, wherein the standard corresponds to a national standard set for an educational curriculum.

48. A computer system according to claim 43, wherein the type of viewer is either a student or a teacher.

49. A computer system for according to claim 43, the memory further comprising an instruction configured to:
store the pieces of content in a database, at least one piece of content being divided into separate portions,
wherein at least one portion is associated with a viewer type attribute indicating the type of viewer for which the portion is to be displayed.

50. A computer system according to claim 49, wherein the at least one portion is included in the instructional material.

51. A computer system according to claim 50, the memory further comprising instructions configured to:
receive an indication of the type of viewer; and
display the instructional material with the at least one portion if the type of viewer corresponds to the viewer type attribute associated with the portion.

52. A computer system for displaying an instructional material, the instructional material comprising a plurality of pieces of content, each piece of content being associated with a plurality of attributes, the computer system comprising:
a processor; and
a memory which stores a plurality of instructions executed by the processor, the plurality of instructions configured to:
receive a request from a viewer to display the instructional material; and
display the instructional material in a first format if the display request is for a setting of a first type and displaying the instructional material in a second format different from the first format if the display request is for a setting of a second type different from the first type.

53. A computer system according to claim 52, wherein the type of setting relates to the size of the audience viewing the instructional material.

54. A computer system according to claim 53, wherein the type of setting is one to many, one to few or one to one.

55. A computer system according to claim 54, wherein the instructional material is displayed with more images and less text for a one to many setting type than for a one to few or a one to one setting type.

56. A computer system according to claim 52, the memory further comprising instructions configured to:
receive an indication of the type of setting; and
display the instructional material in either the first format or the second format based on the received indication.

57. A computer system for developing instructional material, the instructional material comprising a plurality of pieces of content, each piece of content being associated with a plurality of attributes, each piece of content and associated attributes being stored in a database, the computer system comprising:
a processor; and
a memory which stores a plurality of instructions executed by the processor, the plurality of instructions configured to:
receive a search request, the search request including one or more terms;
display a list of icons associated with pieces of content in the database corresponding to the terms of the search request;
place an icon from the displayed list in a workspace window in response to a first received indication, the workspace window displaying icons of pieces of content included in the instructional material; and
create a relationship for the icon placed in the workspace window with at least one other icon in the workspace window in response to a second received indication.

58. A computer system according to claim 57, the memory further comprising an instruction configured to:
display a piece of content in an editing window in response to the selection of an icon corresponding to the piece of content in the workspace window.

59. A computer system according to claim 58, the memory further comprising an instruction configured to:
change the piece of content displayed in the editing window in response to a third received indication.

60. A computer system according to claim 58, the memory further comprising an instruction configured to:
display at least one other piece of content having a relationship with the piece of content corresponding to the selected icon.

61. A computer system according to claim 57, the memory further comprising an instruction configured to:
display the plurality of attributes associated with a piece of content in an editing window in response to the selection of an icon corresponding to the piece of content in the workspace window.

62. A computer system according to claim 61, the memory further comprising an instruction configured to:
change at least one of the plurality of attributes in response to a third received indication.

63. A computer system according to claim 57, the memory further comprising an instruction configured to:
determine a placement of the piece of content corresponding to the icon placed in the workspace window relative to another piece of content included in the instructional material.
